(19) United States
(12) Patent Application Publication
(10) Pub. No.: US 2026/0036731 A1
(43) Pub. Date: Feb. 5, 2026

(54) REFLECTIVE FABRY-PÉROT (F-P) RESONANT STRUCTURES AND METHODS OF TUNABLE PLASMONIC COLOR PRINTING

(71) Applicant: Purdue Research Foundation, West Lafayette, IN (US)

(72) Inventors: Sarah N. Chowdhury, Albany, NY (US); Piotr Nyga, Wygledy, Mazowieckie (PL); Alexander V. Kildishev, West Lafayette, IN (US); Alexandra Boltasseva, West Lafayette, IN (US); Vladimir M. Shalaev, West Lafayette, IN (US); Jeffrey Simon, Bellbrook, OH (US); Karthik Pagadala, West Lafayette, IN (US); Michal P. Nowak, Legionowo, Mazowieckie (PL); Colton Fruhling, Lafayette, IN (US); Ludmila J. Prokopeva, West Lafayette, IN (US)

(21) Appl. No.: 18/657,957

(22) Filed: May 8, 2024

Related U.S. Application Data
(60) Provisional application No. 63/501,079, filed on May 9, 2023.

(51) Int. Cl. G02B 5/28; B41M 3/14; B41M 5/26; B41M 5/41; B41M 5/44

(52) U.S. Cl. CPC G02B 5/285; B41M 3/14; B41M 5/262; B41M 5/41; B41M 5/443; B41M 2205/04; B41M 2205/36; B41M 2205/38

(57) ABSTRACT

Plasmonic color printing by fabricating a Fabry-Pérot (F-P) resonant structure on a substrate. The F-P resonant structure includes a reflective layer, a dielectric spacer layer overlying the reflective layer, and a random metal film (RMF) layer that overlies the dielectric spacer layer and has a nanostructure. The F-P resonant structure is photomodified using a laser, which induces changes in the nanostructure of the RMF layer. These changes are tailored to produce desired changes in the light-scattering and reflective properties of the RMF layer. As a result, by tailoring the photomodifications and the changes it produces, the color-generated by illumination filtered through and reflected from the F-P resonant structure can be tailored to a desired hue.

### CROSS-REFERENCE TO RELATED APPLICATIONS

This application claims the benefit of provisional U.S. Patent Application No. 63/501,079 filed on May 9, 2023, the contents of which are incorporated herein by reference.

### STATEMENT REGARDING FEDERALLY SPONSORED RESEARCH OR DEVELOPMENT

This invention was made with government support under FA9550-21-1-0299 awarded by the Air Force Office of Scientific Research, under N00014-20-S-B001 awarded by the Office of Naval Research, under DGE-1842166 awarded by the National Science Foundation, under DE-SC0017717 awarded by the U. S. Department of Energy and under N00014-21-1-2026 awarded by the Office of Naval Research. The government has certain rights in the invention.

### BACKGROUND OF THE INVENTION

The invention generally relates to printing and color generation on solid surfaces, and more particularly to reflective Fabry-Pérot (F-P) resonant structures and methods of tunable plasmonic color printing.

Plasmonic color is the structural coloring resulting when light scatters when it passes through a transparent or semi-transparent material due to the nano-or microstructural properties of the material. Plasmonic colored materials, structures, and nanostructures are well known historically, most colloquially in their application as stained-glass windows, due to their ability to produce colors that vary with different ambient illumination. The Roman Lycurgus Cup, for example, exhibits dichroic behavior—appearing red if the source of illumination is reflecting off its surface or green if the illumination source is behind it.

The capability of plasmonic nanostructures to produce vivid colors on solid surfaces has inspired researchers towards finding an application for them as a fade-free and environmentally friendly solution to color generation rather than bleaching dyes and toxic pigments. Currently, color generation using plasmonic structures has been done with different fabrication methods such as electron-beam lithography, ion milling, and nanoimprint lithography. Although these processes enable subwavelength resolution printing and tunability, they rely on expensive fabrication methodologies and are therefore not industrially scalable nor suitable for large-scale fabrication and applications.

Likewise, alternative methods for color generation including lithography-free optical absorbers, resonant cavities, thin-film multi-layered structures, and metal-dielectric composites have seen more common applications due to their scalability, sustainability, and economic advantage. Particularly, multilayer stacks produced using the aforementioned methods that generate Fabry-Pérot (F-P) resonances have been demonstrated to produce colors across a broad spectral range. However, the multilayer stacks generate specific colors based on changing the materials and/or thickness of the layers within the stack. Therefore, tailoring the multilayer stacks across a wide range of colors requires fabricating a new structure for each corresponding color and is therefore time-intensive and costly.

Finally, semi-transparent random metal films (RMFs) have been recently employed for color printing applications. RMFs are discontinuous metal films that absorb a broad spectrum of illuminated light due to their random morphology and pseudo-fractal nanostructures. The clustered nanostructures have non-uniform light absorption, contributing to significant inhomogeneous broadening. RMFs can harness the electromagnetic energy around the voids or regions of discontinuity within their nanostructures, commonly known as “hotspots,” where the local field are significantly enhanced compared to incident light. Previous work has demonstrated that laser photomodification of RMFs can modify the structure of the thermally sensitive RMF layer through local heating in the nanostructures, resulting in selective melting and fragmentation.

In light of the aforementioned information, it would be advantageous to provide a method of harnessing the aforementioned modification of RMFs in order to produce a method of color generation for color printing that is environmentally friendly and dye-free as well as industrially scalable and tunable.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods capable of color printing and generation on solid surfaces and reflective Fabry-Pérot (F-P) resonant structures, as well as structures formed by the methods.

According to a nonlimiting aspect of the invention, a method of tunable plasmonic color printing includes fabricating on a substrate surface a reflective Fabry-Pérot (F-P) resonant structure that has a random metal film (RMF) layer having a nanostructure, and photomodifying the nanostructure of the RMF layer to produce spectral and polarization-selective changes in the RMF layer which affect scattering, transmittance, reflectance, and/or absorption characteristics thereof so that the RMF layer exhibits different colors when illuminated by different forms of illumination.

According to another nonlimiting aspect of the invention, a reflective Fabry-Pérot (F-P) resonant structure, the F-P resonant structure includes a reflective layer, and a random metal film (RMF) layer having a nanostructure that covers the reflective layer.

In some configurations, such an F-P resonant structure may include a reflective layer, a dielectric spacer layer overlying the reflective layer, and/or a semi-transparent lossy metal top layer as the RMF layer. In these and other configurations, the RMF layer may be silver (Ag), and/or the dielectric layer may be silicon dioxide (silica; SiO₂), and/or the reflective layer may be silver.

Other aspects of the present invention include F-P resonant structures fabricated by a method comprising steps as described above.

Technical aspects of methods and F-P resonant structures as described above preferably include the ability to fabricate and photomodify an F-P resonant structure on a substrate such that the F-P resonant structure produces desired colors, thereby generating (“printing”) color on the substrate. The photomodification is performed to create local changes in the nanostructure of an RMF layer of the F-P resonant structure. Such local photomodifications result in spectrally and polarization-selective nanostructural changes which affect the light-scattering, transmittance, reflectance, and absorption characteristics of the RMF layer. By targeting the changes produced by photomodification, a targeted change in spectral properties of the RMF layer can be affected, resulting in a desired color being produced when the F-P resonant structure is illuminated.

Other aspects and advantages will be appreciated from the following detailed description.

### BRIEF DESCRIPTION OF THE DRAWINGS

FIG. 1 is a schematic representation of a lossy F-P resonator having an F-P resonant structure and layers thereof on a glass substrate in accordance with a non-limiting embodiment of the invention.

FIG. 2 is a scanning electron microscope (SEM) image of the RMF layer of an F-P resonant structure of FIG. 1.

FIG. 3 is a graph plotting reflectance spectra of different lossy resonator structures. The thickness (ta) of the dielectric spacer layer is varied from 50 to 500 nm, where t_{d}=150 nm shows interference dips within a region of interest. A laser photomodification wavelength with bandwidth, Δv=10 nm is indicated by vertical lines with the selected region. In the graph, each reflectance spectrum corresponding to the dielectric thickness is shifted and normalized.

FIGS. 4A-4E relate to investigations of spectral power and illumination.

FIG. 5 contains a series of SEM images of laser-modified areas of an RMF layer with laser photomodification wavelengths of λ=400 nm (0.65 mJcm⁻² and 2.64 mJcm⁻²) (top panels) and λ=800 nm (1.34 mJcm⁻² and 2.88 mJcm⁻²), respectively (bottom panels).

FIG. 6 is a graph plotting reflectance spectra of non-modified F-P resonant structure samples and laser photomodified (2.88 W/cm²) F-P resonant structure samples with a photomodification wavelength, λ=800 nm for (θᵢ=45°) and (θᵢ=70°).

FIG. 7 schematically represents an optical system capable of performing color printing on an F-P resonant structure in accordance with some principles of the invention.

### DETAILED DESCRIPTION OF THE INVENTION

The intended purpose of the following detailed description of the invention and the phraseology and terminology employed therein is to describe what is shown in the drawings, which depict and/or relate to one or more nonlimiting embodiments of the invention, and to describe certain but not all aspects of the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended provisional claims, and not the detailed description, are intended to particularly point out subject matter regarded to be aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the F-P resonant structure during its use and/or as represented in the drawings. All such relative terms are useful to describe the illustrated embodiment(s) but should not be otherwise interpreted as limiting the scope of the invention.

In one aspect of the present invention, a method of tunable plasmonic color printing is provided. The method includes fabricating an F-P resonant structure on a desired substrate and photomodifying the F-P resonant structure such that it produces desired colors, thereby generating (“printing”) color on the substrate. The F-P resonant structure comprises layers which filter and then reflect incoming light or illumination. The photomodification results in a nanostructure which creates light interference effects which are dependent on the angle of incidence of the light. As a result, targeted photomodifications of F-P resonant structures can be utilized to create specific reactions to incoming light, thereby providing specific colors. When applied to a substrate, the F-P resonant structure, once modified, serves as a color-generating element on the substrate, thereby achieving plasmonic color printing.

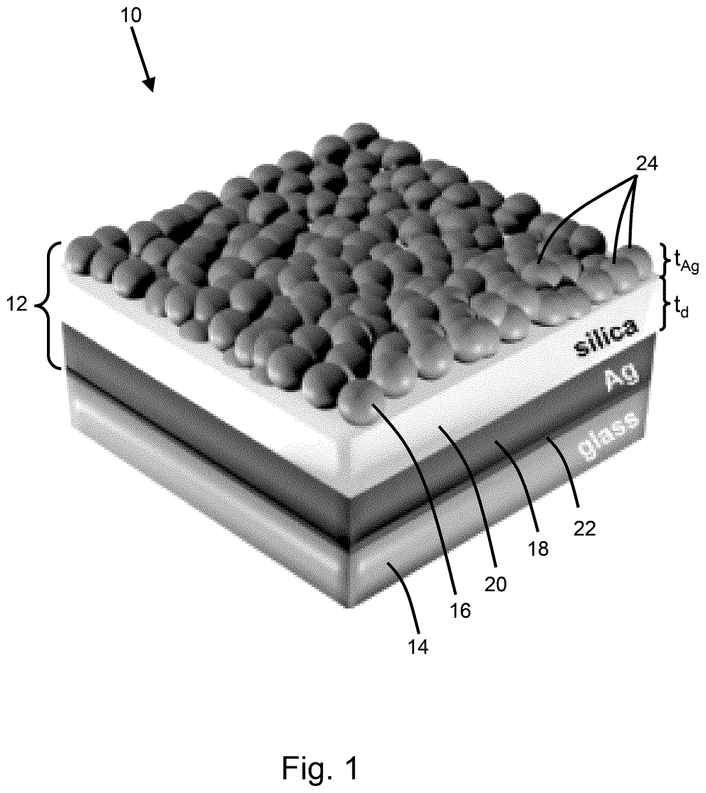

As illustrated in FIG. 1, a lossy F-P resonator 10 in accordance with one nonlimiting embodiment includes an F-P resonant structure 12 carried by a substrate 14. The F-P resonant structure 12 includes a metal reflective layer 18, a dielectric spacer layer 20 on the reflective layer, and an RMF layer 16 as a top (uppermost) layer. An adhesion layer 22 of titanium (Ti) adheres the F-P resonant structure to the substrate. In investigations leading to the present invention, the F-P resonant structures 12 were fabricated on glass substrates 14. Each F-P resonant structure 12 was formed by a thin, semi-transparent lossy metal top layer that served as the RMF layer 16, the metal reflective layer 18, and the dielectric spacer layer 20 therebetween. The RMF layer 16 covers the metal reflective layer 18 and the dielectric spacer layer 20. In the investigations, the RMF layers 16 were formed of silver (Ag), the reflective layers 18 were formed of silver (Ag), and the dielectric spacer layers 20 were formed of silicon dioxide (silica; SiO₂). In the particular embodiment of FIG. 1, the RMF 16, spacer layer 20, and reflective layers 18 had thicknesses of 20 nanometers (nm), 150 nm, and 100 nm, respectively, though lesser and greater thicknesses are foreseeable. The thickness of the substrate 14 was 1 millimeter (mm). The RMF layer 16 was utilized to adjust the spectral width of F-P-like cavity modes of the spacer layer 20. The thickness tag of the RMF layer 16 was chosen to be 20 nm in order to have a broad optical response and increase the overall structure's robustness and stability, for example, against degradation and oxidation. The spacer layer 20 was chosen to promote variation of colors through F-P-like modes, therefore enabling a fabricator to modify the reflected (observed) color with respect to normal light reflecting and filtering through the resonant structure 12. The dielectric (SiO₂) spacer layer 20 preferably has a wavelength-scale thickness (t_{d}). An adhesive layer 22 is disposed between the F-P resonant structure 12 and the surface of the substrate 14 upon which it is fabricated. The adhesive layer 22 is preferably, though not necessarily, formed of titanium and indicated as having a thickness of about 5 nm, though lesser and greater thicknesses are foreseeable.

The multilayered nature of the F-P resonant structure 12 created F-P-like interference effects relying on phase accumulations through multi-pass circulation within the dielectric spacer layer 20. These interference effects generate colors based on illumination being filtered through and reflected by the F-P resonant structure 12. Colors were observed in the reflection mode.

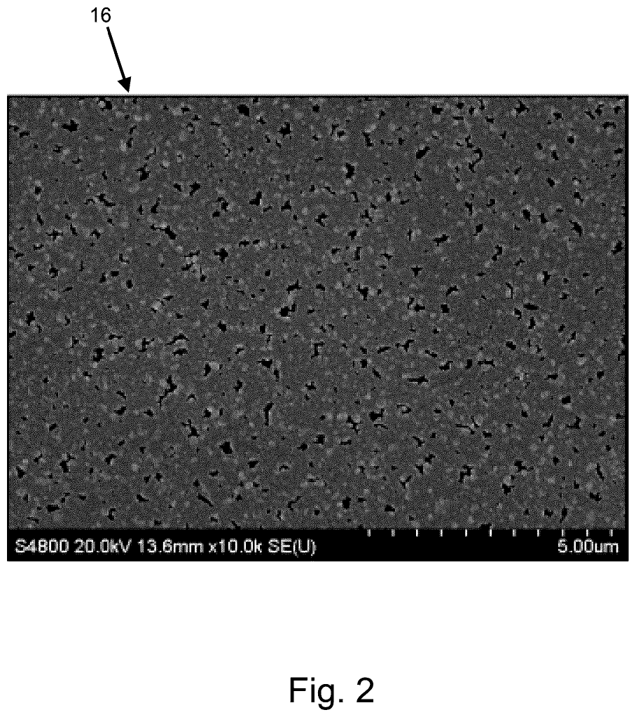

As seen in FIG. 2, the RMF layer 16 has a random and discontinuous structure at the nanostructural level made of nanoparticles 24. In this embodiment, the RMF layer 16 is a discontinuous random metal film with voids that forms a lossy metallic layer. Subsequent investigations demonstrated the overall uniformity and stability of the structure RMF layer 16 in application. Tests of the reflectance properties of the RMF layer at four different locations showed their uniform properties. Reflectance spectra for polarized light at a 20 degree angle of incidence for four different sample spots within the RMF layer were taken. A near-perfect overlap between two forms of polarized light (s-polarized light and p-polarized light) evidenced the uniformity of the RMF layer and its suitability for large-area printing. Further investigations showed that the reflectance properties at three different angles of incidence (20°, 45°, and 70°) were not impacted by time, having the same properties four months after initial fabrication. The investigations confirmed that the spectral response, and therefore the color generated by the F-P resonant structure, is robust and time-resistant. As a result of the aforementioned experimentation, a thickness (t_{Ag}) of 20 nm was chosen as a suitable thickness for the RMF layer 16 due to being above the percolation threshold and demonstrating better stability compared to thinner silver films.

In the investigations, the F-P resonant structures 12 were fabricated in a single process using an electron-beam physical vapor deposition (PVD) technique known in the art. Through photomodification of the RMF layer 16, structural changes were induced in its nanostructure which furthermore changed the effect the RMF layer has on light filtered through it, thereby inducing color changes to an observer. High-intensity lasers were directed towards the RMF layer 16 to melt, modify, and change the structure of the nanoparticles 24 that form the discontinuous, random nanostructure of the RMF layer. Such local photomodification resulted in spectrally and polarization-selective changes which affected the scattering, transmittance, reflectance, and absorption characteristics of the RMF layer 16. By changing these characteristics, the properties of the light filtered through and reflected from the RMF layer 16 (and therefore the F-P resonant structure 12) are changed as well. By intentionally manipulating these properties through photomodification, specific colors may be generated with an F-P resonant structure 12.

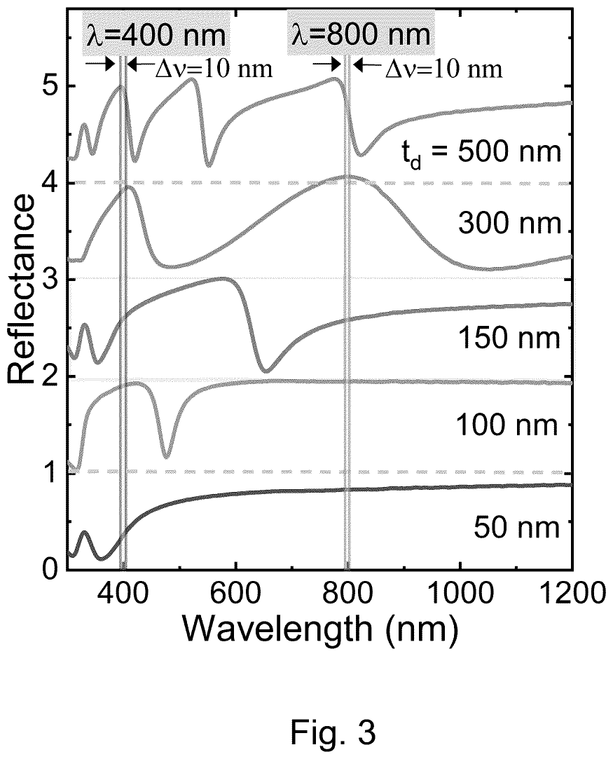

For a F-P-like resonator 10, an incident light undergoes multiple passes with spectral locations of interference dips being mainly dependent on the thickness (t_{d}) of the dielectric spacer layer 20. Moreover, the broadening of the dip and quality depends on the contribution from the random morphologies of the RMF layer 16. The thickness ta of the dielectric spacer layer 20 played a crucial role in developing this structure for a wide range of optical spectra sensitive to the angle of incidence. To experimentally demonstrate the interference dips and identify a region of interest within the visible spectrum in the investigation, the dielectric spacer layer thickness ta was varied from 50 nm to 500 nm. FIG. 3 shows that the number of interference dips increased with increasing dielectric layer thickness, characteristic to F-P-like resonators. A high-intensity laser impinged on a discontinuous surface such as an RMF layer 16 can thermally melt, modify, and change the morphology of nanoparticles 24 that form the discontinuous surface. Such local photomodification results in spectral and polarization-selective changes in the scattering, transmittance, reflectance, and absorption spectra due to the gradual structural modifications occurring in the nanometer-scale areas. A laser scanning setup with linearly polarized femtosecond laser pulses (repetition rate 1 kHz, pulse duration 100 fs) and operating wavelengths both at λ=800 nm and λ=400 nm was used for photomodifications of the structure, and generated ultrashort femtosecond laser pulses with a bandwidth of Δv=10 nm. The experimental study of the F-P resonant structure 12 with different dielectric spacer layer thicknesses ta indicated that a silica spacer layer thickness of t_{d}=150 nm enabled photomodification with femtosecond pulses both at λ=800 nm and λ=400 nm. FIG. 3 evidences that such a structure has an absorption band tail near the photomodification laser wavelengths of 400 and 800 nm.

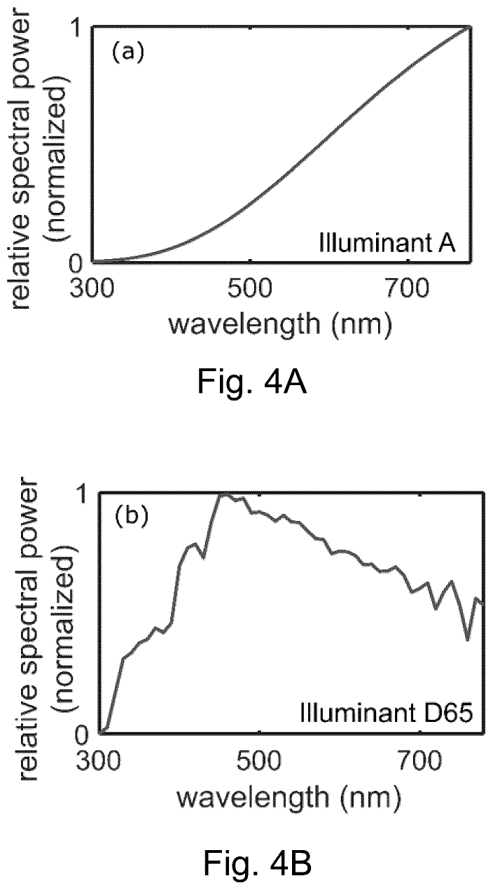

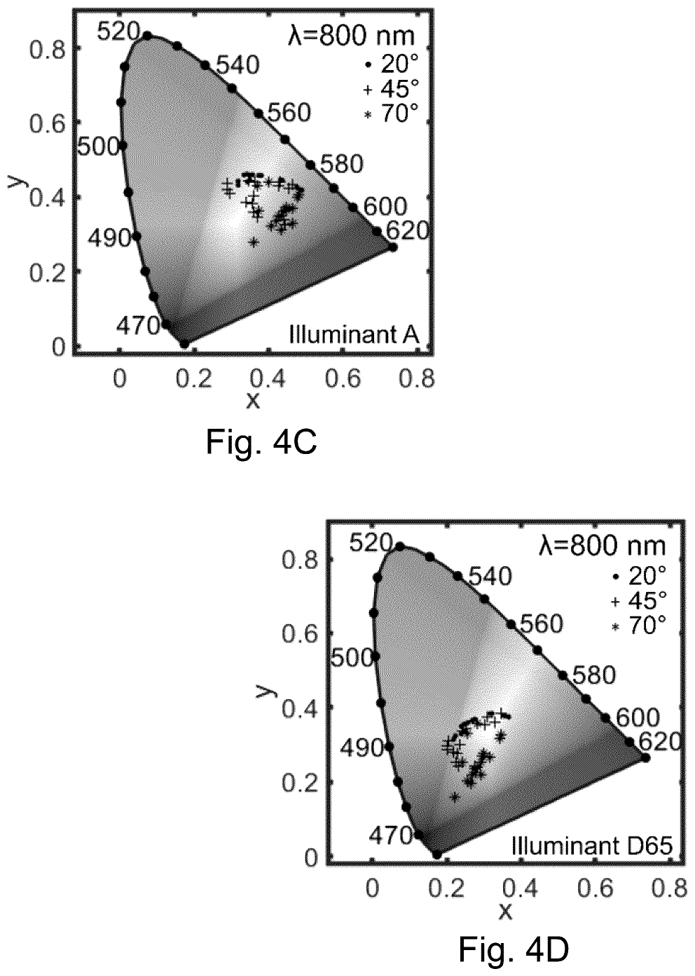

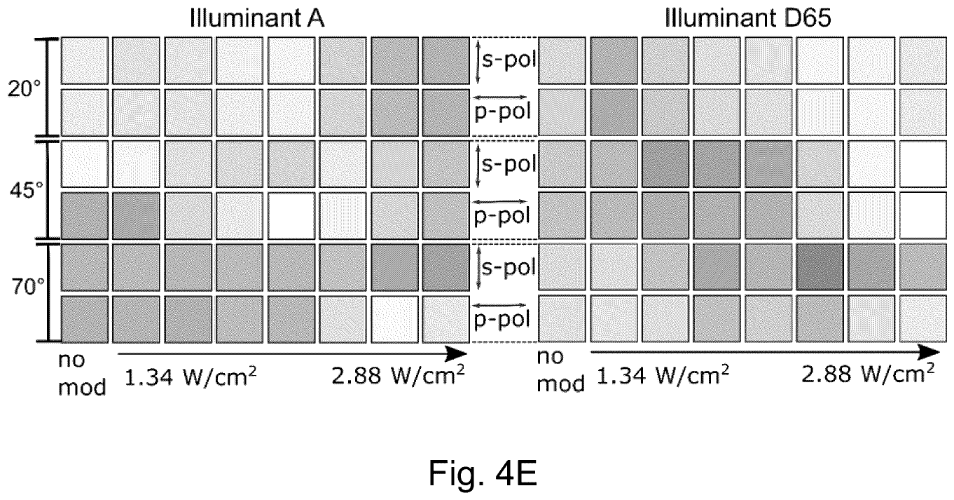

In the case with F-P type interference effects, within the cavity, variation and spectral reshaping in the reflection and transmission beam occurs due to multiple passes and phase change of the beam. Hence, depending on the angle of incidence (AOI) of the beam, variations can be seen in the optical distance traveled by the beam as well as polarization dependence. Another critical feature of the observed colors from this structure is the type of standard illuminants used to record images under different illumination settings. Although there are numerous standard light sources defined by The International Commission on Illumination (CIE), the investigations focused on the effect of two well-known illuminants: illuminant A, which is the spectral distribution of incandescent light with a correlated color temperature of 2856 K and illuminant D65, which is an average daylight (temperature 6504 K) including the ultraviolet wavelength region. FIGS. 4A and B show the spectral power distribution of CIE illuminants A (FIG. 4A) and D65 (FIG. 4B). CIE 1931 chromaticity diagrams with illuminant A (FIG. 4C) and D65 (FIG. 4D) are shown to have different sets of colors with varying laser power and angle of incidences (AOI) of θᵢ=20°, 45°, 70°. The colors generated for unmodified (no mod) and laser photomodified samples under illuminants A and D65 show angular and polarization dependence. Laser power density is varied from 1.34 to 2.88 W/cm² for operating photomodification wavelength λ=800 nm with linearly polarized light, and s and p polarization are denoted by s-pol and p-pol for each set of AOI. In FIG. 4E, RGB colors with illuminants A and D65 show a broad range for angular dispersion, polarization, and laser photomodifications. The corresponding value of AOI and polarization of light are marked with black dotted lines in the middle of FIG. 4E. The reflectance spectra obtained for a variation of AOI, polarization state, and the kind of illuminant results in RGB values spanning the CIE color map. This demonstrates the tailorability of specific functionalities of a photomodified F-P resonant structure depending on the illumination conditions.

Laser post-processing of an as-deposited sample of an F-P resonant structure was conducted by varying the laser power density on the sample from 1.34 to 2.88 W/cm² for operating at a photomodification wavelength of λ=800 nm with linearly polarized light. The reflectance spectra of the laser photomodified areas evidenced distinct changes occurring as the laser intensity increased. The changes resulted in different observed colors under various illuminants. The stability of the laser-modified areas was shown with invariance in the optical spectra within a time span of several months at room temperature and atmospheric pressure, confirming that the unmodified and photomodified P-F resonant structures and their colors were robust and fade-free. The range of colors of these optical samples can be visualized from the CIE color map (FIGS. 4C and 4D), which was obtained from the measured reflectance spectra of the modified areas. For illuminant A, RGB colors span from green (0.84, 1, 0.58) to orange (1, 0.58, 0.46) through pink (1, 0.92, 0.62) (FIG. 4E). The RGB colors obtained for illuminant D65 belong to a completely different hue from violet (0.7, 0.72, 1) to blue (0.09, 0.94, 1) (FIG. 4E). The damage threshold for this structure was around 4 W/cm². where the laser photomodified area had completely removed the top RMF layer and had no angle dependence of the reflected color.

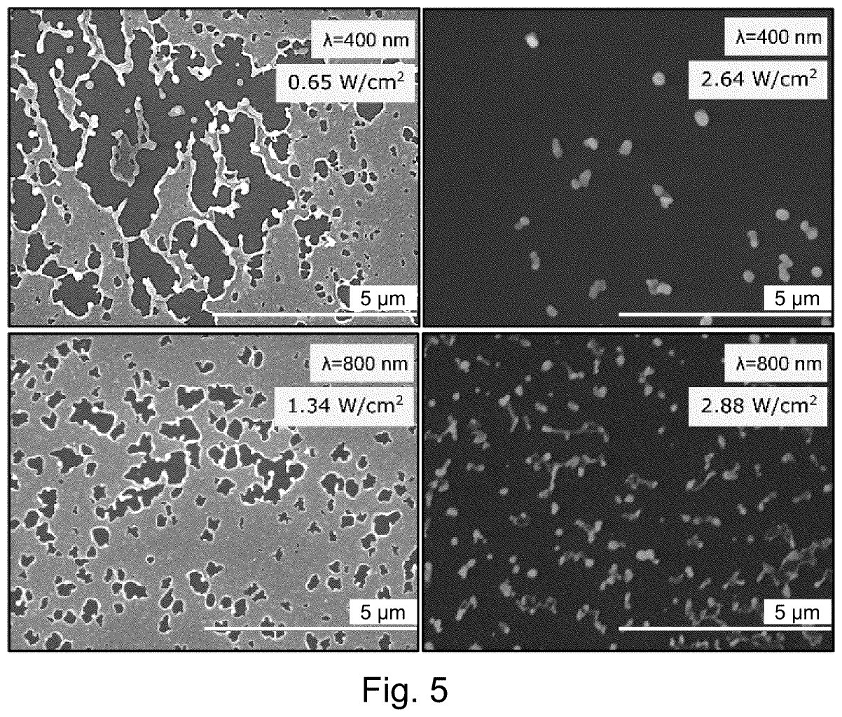

The significance of the change in observed color can be illustrated and analyzed with the images in FIG. 5, which contains SEM images for high and low power intensity with photomodification wavelengths of λ=800 nm and λ=400 nm. The images show the morphological changes associated with progressively greater laser intensity. At higher laser power, the RMF layer surface is thermally ablated, with gradual delamination and dewetting to droplet-like structures. During the photomodification process, the discontinuous surface of the RMF layer 16 generally fragments into smaller nanoparticles and gradually turns into spheroids as the laser fluence increases. The effect was more prominent for λ=400 nm, where the surface quickly changed to droplet-like morphology, and a near-white color (RGB: 1, 0.99, 0.97) was observed. FIG. 5 shows the almost complete removal of the entire RMF layer with λ=400 nm at higher power due to known particle delamination and laser cleaning effects. This extreme morphological change agreed well with the observed spectral reflectance resembling the bulk behavior with only a dielectric-coated Ag bottom mirror layer. Higher laser power density at λ=400 nm had a strong effect due to its faster aggregation to smaller spheroids where higher energy was transferred from the incident beam to the RMF layer. Moreover, with this resonator, there was a shallow reflectance (about 10%) around 351 nm (FIG. 3), which made the pulse at 2=400 nm more strongly absorbed by the RMF. For 2=800 nm the change was more gradual, starting from the longer wavelength (as seen in FIG. 3) and a gradual thermal accumulation to spheroids was observed as the laser fluence increased (FIG. 5). The surface morphological change induced by λ=400 nm and 800 nm can also be described through the optical penetration depth at the photomodification wavelength of the laser. For λ=400 nm, the penetration depth is small (about 28.3 nm), which is comparable to the RMF layer thickness (t_{Ag}=20 nm). So, laser pulses were mostly absorbed by the top RMF layer, thermally ablating both along lateral and vertical directions. Hence, with a moderate increment in fluence, the RMF layer 16 is quickly sintered and delaminated, revealing the underlying dielectric spacer layer 20. For λ=800 nm, the optical penetration depth was around 171 nm, indicating the laser passed through the RMF layer 16. As a result, light was absorbed volumetrically, extending along a narrow vertical region towards the reflector layer. This ensured that when the laser passed through the resonant structure, it did not have a pronounced heating effect laterally along the surface, and thermal heating was confined within a relatively small region.

In the investigations, a laser scanning setup with linearly polarized femtosecond laser pulses was used to produce photomodifications of RMF layer-containing F-P resonant structures. The laser was pulsed at a rate of 1 kilohertz (kHz) for a duration of 100 femtoseconds (fs) and operated at wavelengths of both 800 nm and 400 nm. The laser power density (i.e., intensity) was from 0.65 to 2.64 Watts per cubic centimeter and 1.34 to 2.88 Watts per cubic centimeter for wavelengths of 400nm and 800 nm, respectively. Any manner of experimentation, programming, or theoretical application may be applied to determine other suitable or optimal photomodifications to produce desired changes and generated colors. In the investigations, a Python-generated code provided various patterns for photomodifications of the RMF layers.

In one nonlimiting example, a lossy resonator 10 formed from a lossy Ag layer 16, silica spacer layer 20, and a silver reflective layer 18 deposited on a glass substrate 14 was fabricated in a single process using an electron-beam physical vapor deposition (PVD) technique. The glass substrates 14 were pre-cleaned with an acidic solution (3 parts H₂SO₄: 1 part H₂O₂) for 15 minutes and thoroughly rinsed with distilled water. After drying out with nitrogen gas, the substrates 14 were sonicated in solvents (toluene, acetone, and isopropyl alcohol) and dried thoroughly. Next, a titanium adhesion layer 22, silver reflective layer 18, silica spacer layer 20, and lossy Ag layer 16 were deposited in a high-vacuum deposition chamber, base pressure 3.33×10⁻⁶ mbar at room temperature. Silicon dioxide (SiO₂, 99.99% purity), titanium (Ti, 99.99% purity), and silver (Ag, 99.99% purity) were used for fabricating all structures. The deposition rate (1 Å/s for all materials) and layer thickness were monitored with a quartz crystal microbalance. Laser photomodification of the lossy resonator 10 was performed in ambient conditions using 800 nm femtosecond pulses generated by a Ti: Sapphire femtosecond seed laser and ultrafast amplifier (1 kHz, 100 fs, 800 nm, linear polarization). To perform photomodification at 400 nm, an inserted second harmonic generation (SHG) crystal doubled the frequency of the original femtosecond pulse. A TTL shutter controlled the number of pulses for each photomodification event. A Variable ND Filter controlled the pulse power, and thus, the color resulting from the selective modification of the sample. The laser beam was focused using a single lens and the 1/e² Gaussian beam size was determined using the knife-edge technique. The beam size calculated for λ=800 nm is 300 μm and λ=400 nm is 100 μm. To print areas of uniform color, samples were mounted on a motorized XYZ stage capable of raster scanning and controlled with a computer interface. To ensure uniformity of modification over the large area, we use a 50 μm X and Y-axis (raster) step. Software code for instrumentation control patterned various designs onto the samples. A digital photography camera captured the color images of the printed structures at multiple angles while a rotation stage precisely controlled the position of the sample.

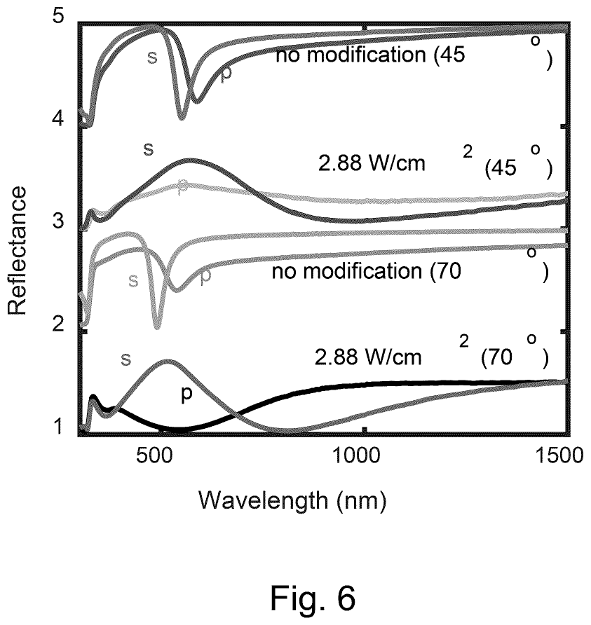

FIG. 4E shows the colors of unmodified and photomodified surfaces with illumination from both s-polarized and p-polarized light. With larger AOI, there was a significant difference in mapped colors obtained from reflected s-and p-polarized light. Correspondingly, the change in the polarization state of light with rendered colors was more evident for photomodification wavelength λ=800 nm. In FIG. 6, a change and shift in resonance is observed from observing s-polarized to p-polarized light and vice versa. For the unmodified sample at θᵢ=45° and a wavelength of 550 nm, the structure reflected the p-polarized light and absorbed (resonated) the s-polarized light. For the sample at the same incident angle and a wavelength of 588 nm, the structure absorbed (resonated) the p-polarized light and reflected the s-polarized light. This demonstrated that as the light polarization was switched from s-polarized to p-polarized, there was a redshift in the resonance of the structure. Thus, within the 477-674 nm range, polarization-switchable reflectivity occurred at two corresponding wavelengths. After photomodification with a higher laser intensity (2.88 W/cm²) and photomodification operating wavelength λ=800 nm, this effect was very broad throughout the whole visible spectrum, spectrally reflecting the s-polarized light from 418 to 677 nm and then switching to p-polarized light up to the near infra-red regime. Similar phenomenon happened for the un-modified sample at θᵢ=70° within the range of 436 to 563 nm (i.e., within the green colors), where the resonance behavior altogether blue shifted when the light polarization was switched from s-polarized to p-polarized. This polarization dependence originates from the strong correlation of the near-field anisotropy effects of the connected nanoparticles 24 in the RMF layer 16 along the incident light polarization direction. When light travels through the island-like RMF layer 16, it encounters multiple scattering and extinction events along the beam path. This effect is more prominent at higher angles relative to normal incidence, where significant scattering effects arise from the discontinuity along the traverse direction. Hence, this discontinuity arising from complex Ag aggregate topologies, introduces near-field scattering along the beam path changing its polarization at the detector. At the detector, when the polarization state of light (s or p-polarized), is recorded, a blue shift is observed of the resonance peak behavior (either s or p) for θᵢ=70° compared to θᵢ=45°. The depolarization factor causes different interactions for s-and p-polarized light depending on the component of the electric field along the plane. The island-like cluster in the RMF layer has a statistical superposition of Ag nanoparticles, each with a different depolarization factor. The shape and orientation of any inclusion or nanoparticle, in general, can be assigned to a depolarization value or geometric factor where the value for uniform spheroidal inclusions is L=⅓. This has a direct relationship with polarizability of the nanoparticle. For shapes that deviate from spherical symmetry, the polarizabilities vary along different spatial directions. From that correlation, depolarization factor increases for elongated clusters or oblate spheroids (depolarization factor, L>⅓) resulting in the shifting of observed peaks in the shorter wavelength regime. Therefore, at θᵢ=70°, the polarized white light beam encounters more Ag cluster topology resembling the shape of oblates, relative to normal incidence along the surface that increases the depolarization factor and shifts the peak to shorter wavelength. For the photomodified areas, a similar angular effect takes place. But, in this case, the resonance and reflectance dip gradually disappear due to local photomodification, partially removing the RMF layer. This now results in a reflection predominantly from the bottom metal (Ag) reflective layer 18. Hence, although in the case of photomodification, the effect of scattering from large clusters or spheroids can be attributed to the change in polarization, the underlying layers 20 and 18 play a key role in the observed spectra. For photomodified areas, the direction of laser modification or raster scanning is parallel to the photomodification wavelength polarization. Such a striking change in polarization gave a wide range of dramatically different colors and can also switch polarization through angular dispersion and morphological evolution due to laser photomodification (FIG. 5). The effect could be applied to anti-counterfeiting applications and laser marking beyond the visible range due to changes induced in the near-infrared spectral range. Specifically, the next generation color/visual security labels can be equipped with an additional polarization-detection authentication enabling a more advanced and sophisticated security system.

Lossy F-P resonators 10 having F-P resonant structures 12 fabricated in accordance with the methods of the present invention can result in a broad range of colors generated under various illumination characteristics, such as CIE standard illuminant A (incandescent light simulator) and CIE standard illuminant D65 (standard sunlight illuminator). The resulting lossy F-P resonators 10 can have laser-modified areas that result in different colors and illumination strengths with various angles of incidence and for different wavelengths of photomodification and when placed in a dark background or under direct sunlight. Many various colors can be achieved under the two different illumination conditions: standard incandescent light (Illuminant A) and standard sunlight (Illuminant D65). Investigations leading to the invention also resulted in the formation of optical images of reproductions of known images using the method of the present invention, that illustrated a very broad range of hues and clarity capable of being produced by the present method. A wide gamut of colors from green to yellow and violet to blue can be produced.

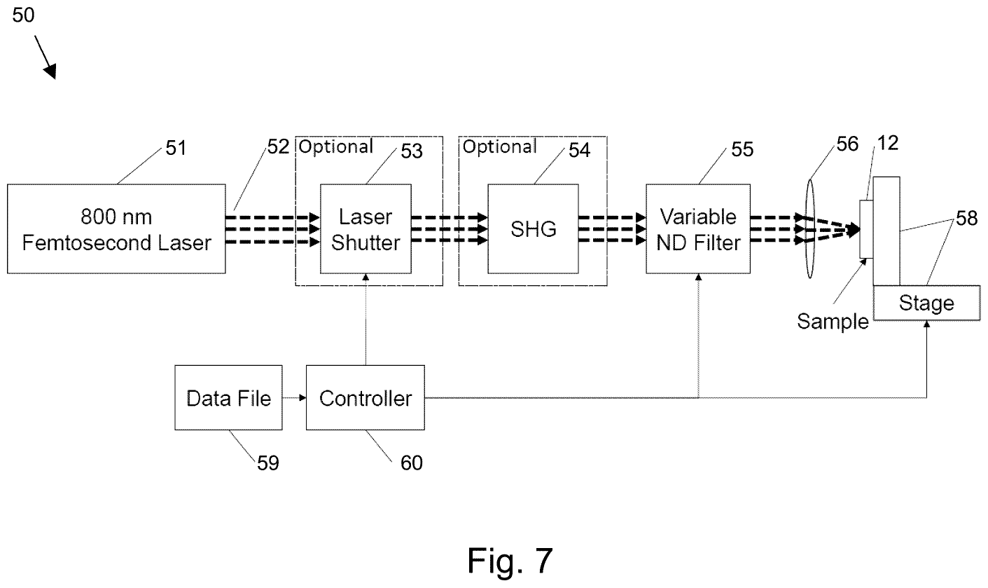

Turning now to FIG. 7, an optical system 50 configured for performing color printing on an F-P resonant structure 12 in accordance with certain aspects disclosed herein is shown. In one nonlimiting embodiment, a femtosecond laser 51 (e.g., a Ti: Sapphire oscillator that feeds a nonlinear amplifier) generates an 800 nm femtosecond pulse 52 at a repetition rate of 1 kHz that passes to an optional laser shutter 53. The laser shutter 53 controls the laser exposure time on the sample. When the shutter 53 is in an open position, the laser pulse 52 passes through the shutter 53 to an optional second harmonic generation (SHG) crystal 54. The SHG crystal 54 converts the femtosecond pulse 52 to a wavelength of half the original wavelength (e.g., 400 nm) to provide flexibility when color printing. The femtosecond pulse 52 passes through a variable ND filter 55 that controls the laser intensity reaching the sample F-P resonant structure 12, for example by controlling the pulse power, and thus, the color resulting from the selective modification of the resonant structure 12. The sample F-P resonant structure 12 is mounted on a three-axis sample stage 58 positioned downstream of a focusing lens 56, which is used to focus the laser beam onto the sample F-P resonant structure 12. A data file 59 containing design information is electronically transferred to a system controller 60, which interprets the data file 59, initiates laser printing on the structure 57 by actuating the laser shutter 53, adjusts the optical density of the variable ND filter 55, and controls motorized actuators on the sample stage 58. To perform color printing, images data files 59 are loaded into the electronic control computer 60. The variable ND filter 55 is manually set to a predetermined power to control the color. For the first color, the computer 60 actuates the stage 58 to move to the first point in a specific color's image and then opens the shutter 53 for the exposure time. The sample F-P resonant structure 12 is translated to the subsequent points in the image where it is exposed to the laser pulses 52. The ND filter power is modified for each subsequent color, and the image is again written to the sample F-P resonant structure 12.

In view of the above, the color displayed by the nanostructure is not tailored based on costly and time-intensive changes to the structure or material, but by photomodification of the existing structure. As a result, a preferred capability of the invention is the ability to fabricate a common multilayer structure even if many different colors are desired.

Colors capable of being produced using the method described above were demonstrated experimentally to be stable and robust over at least several months. Additionally, the method demonstrated how observed colors produced by the structure depended on the properties of the illumination reflected and from which colors were produced. The observed colors were dependent on the characteristics of the illuminant light the F-P resonant structure filtered and reflected. Therefore, the F-P resonant structures 12 were tested using standard (according to the International Commission on Illumination) incandescent light and average daylight and were demonstrated to be tailorable based on the expected illumination conditions of the color-generated product.

Accordingly, a preferred aspect of the invention is the ability to produce a color-generating F-P resonant structure that provides applications for color printing, and may be tailored for specific substrates or specific illumination conditions. For example, preferred aspects of the present invention include potential advantages and applications in anti-counterfeiting and laser marking, particularly beyond the human visual range. Photomodification of an RMF layer can additionally induce changes in the near-infrared spectral range. Future color generation and security labels can be equipped with polarization-detection authentication, or some other form of spectral authentication outside of the visual range or which are responsive to specific illumination characteristics (scanners) for which the photomodification is tailored.

In summary, the investigated methods provided a dye-free, environmentally-friendly, and industrially scalable manner of color printing and plasmonic color generation, and achieved a broader range of hue than similar alternative color-generating methods which rely on structural modifications of stacked reflective layers.

As previously noted above, though the foregoing detailed description describes certain aspects of one or more particular embodiments of the invention, alternatives could be adopted by one skilled in the art. For example, the relative or absolute thicknesses of the F-P resonant structure layers may change to affect desired spectral properties or allow for alternative photomodification. As such, and again as was previously noted, it should be understood that the invention is not necessarily limited to any particular embodiment described herein or illustrated in the drawings.

1. A method of tunable plasmonic color printing, the method comprising:
fabricating a reflective Fabry-Pérot (F-P) resonant structure on a substrate surface, the F-P resonant structure comprising a random metal film (RMF) layer having a nanostructure; and
photomodifying the nanostructure of the RMF layer to produce spectral and polarization-selective changes in the RMF layer which affect scattering, transmittance, reflectance, and/or absorption characteristics thereof so that the RMF layer exhibits different colors when illuminated by different forms of illumination.

2. The method of tunable plasmonic color printing according to claim 1, wherein the F-P resonant structure comprises a reflective layer, a dielectric spacer layer overlying the reflective layer, and a semi-transparent lossy metal top layer as the RMF layer.

3. The method of tunable plasmonic color printing according to claim 2, wherein the RMF layer comprises silver.

4. The method of tunable plasmonic color printing according to claim 2, wherein the dielectric spacer layer comprises silica.

5. The method of tunable plasmonic color printing according to claim 2, wherein the reflective layer comprises silver.

6. The method of tunable plasmonic color printing according to claim 2, wherein the RMF layer is at least 20 nanometers thick, the dielectric spacer layer is 50 to 500 nanometers thick, and the reflective layer is thicker than the RMF layer.

7. The method of tunable plasmonic color printing according to claim 1, wherein the substrate surface is a surface of a glass substrate.

8. The method of tunable plasmonic color printing according to claim 1, further comprising providing an adhesive layer between the F-P resonant structure and the substrate surface.

9. The method of tunable plasmonic color printing according to claim 8, wherein the adhesive layer comprises titanium.

10. The method of tunable glass plasmonic color printing according to claim 1, wherein the photomodification is performed with a laser.

11. The method of tunable glass plasmonic color printing according to claim 10, wherein the laser produces linearly polarized laser pulses.

12. The method of tunable glass plasmonic color printing according to claim 11, wherein the laser pulses occur at a rate of 1 kilohertz for a duration of 100 femtoseconds.

13. The method of tunable glass plasmonic color printing according to claim 11, wherein the laser pulses are at wavelengths of 800 nanometers and/or 400 nanometers.

14. The method of tunable glass plasmonic color printing according to claim 13, wherein the laser has a power density of 0.65 to 2.64 watts per cubic centimeter at a wavelength of 400 nm.

15. The method of tunable glass plasmonic color printing according to claim 13, wherein the laser has a power density of 1.34 to 2.88 watts per cubic centimeter at a wavelength of 800 nm.

16. The method of tunable glass plasmonic color printing according to claim 1, wherein the F-P resonant structure is fabricated using an electron-beam physical vapor deposition technique.

17. The method of claim 1, further comprising forming an anti-counterfeiting application with the photomodified RMF layer.

18. A reflective Fabry-Pérot (F-P) resonant structure, the F-P resonant structure comprising:
a reflective layer; and
a random metal film (RMF) layer having a nanostructure that covers the reflective layer.

19. The reflective Fabry-Pérot (F-P) resonant structure of claim 18, further comprising:
a dielectric spacer layer disposed between the RMF layer and the reflective layer and overlying the reflective layer.

20. The reflective Fabry-Pérot (F-P) resonant structure of claim 18, wherein the RMF layer comprises a lossy metallic layer.

21. The reflective Fabry-Pérot (F-P) resonant structure of claim 18, wherein the RMF layer comprises laser markings beyond the visible range due to changes induced in the near-infrared spectral range.
